(19) United States
(12) Patent Application Publication
(10) Pub. No.: US 2026/0316266 A1
(43) Pub. Date: Oct. 15, 2026

(54) SYSTEMS AND METHODS OF OBJECT MANIPULATION

(71) Applicant: Walmart Apollo, LLC, Bentonville, AR (US)

(72) Inventor: Santos Cerda, JR., Centerton, AR (US)

(21) Appl. No.: 19/466,057

(22) Filed: Jan. 30, 2026

Related U.S. Application Data
(60) Provisional application No. 63/752,132, filed on Jan. 31, 2025.

(51) Int. Cl. B25J 9/16; B25J 15/06

(52) U.S. Cl. CPC B25J 9/1612; B25J 15/0633

(57) ABSTRACT

Some embodiments relate to a robotic manipulator. The robotic manipulator includes an end effector having a transporter mechanism with one or more transporting surfaces configured to move one or more objects, and a gripping mechanism with a gripping interface configured to interface with the one or more objects. The gripping interface is movable relative to the transporting surfaces and is configured to extend outwardly beyond a plane defined by the one or more transporting surfaces to engage the one or more objects and to retract to a position corresponding to or behind the plane to permit transport of the one or more objects on the transporting surfaces.

### CROSS-REFERENCE TO RELATED APPLICATIONS

This application claims the benefit of U.S. Provisional Patent Application No. 63/752,132, filed Jan. 31, 2025, and titled “Systems and Methods of Object Manipulation,” the entire contents of which are hereby incorporated by reference herein.

### BACKGROUND

In various industrial, commercial, and logistics environments, there is a need to manipulate large numbers of objects, including loading and unloading objects that may be stacked, bundled, or otherwise arranged in bulk. Such environments may involve objects having different sizes, shapes, weights, and surface characteristics, and may present spatial constraints that complicate handling operations.

### BRIEF DESCRIPTION OF DRAWINGS

Various examples will be described below with reference to the following figures.

FIG. 1 is a perspective view of a robotic system for manipulating a plurality of objects, according to some embodiments.

FIG. 2 is a top view of a platform of the robotic system according to some embodiments.

FIG. 3 is a side view of a robotic manipulator according to some embodiments.

FIG. 4 is a perspective view of an end effector including a gripping mechanism and a transporter mechanism, according to some embodiments.

FIG. 5 is a diagram illustrating an example travel path of the end effector between a gripping position and a transporting position, according to some embodiments.

FIG. 6 is an illustration of stacked objects arranged for handling by the robotic system, according to some embodiments.

FIGS. 7A–7C are sequential views illustrating an example process of unloading objects from a trailer using the robotic system, according to some embodiments.

FIG. 8 is a flow diagram illustrating an example method for manipulating objects using the robotic system, according to some embodiments.

FIG. 9 is a block diagram of the robotic system according to some embodiments.

### DETAILED DESCRIPTION

Generally speaking, pursuant to various embodiments, systems, apparatuses, and methods are provided herein useful for object manipulation, including loading, and/or unloading objects in bulk. In some embodiments, a robotic system includes a robotic manipulator on the platform. The robotic manipulator includes an end effector comprising: a transporter mechanism with one or more transporting surfaces configured to move an object thereon and a gripping mechanism with a gripping interface configured to interface with one or more objects to be gripped, wherein the gripping interface is configured to extend outwardly beyond a plane defined by the one or more transporting surfaces and retract to a position corresponding to the one or more transporting surfaces or a position behind the plane defined by the one or more transporting surfaces through the plane defined by the one or more transporting surfaces.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included but is not limited to at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

In some embodiments, a robotic system comprising a platform and a robotic manipulator that grips, via a gripping mechanism of an end effector of the robotic manipulator, and transports, via a transporter mechanism of the end effector of the robotic manipulator, which may be a multi-axis robot arm, objects. A gripping interface of the gripping mechanism interfaces with the plurality of objects by extending outwardly beyond a plane defined by one or more transporting surfaces of the transporting mechanism and retracting to a position corresponding to the transporting surfaces in order for the plurality of objects to be transported. The one or more transporting surfaces are generally upright when in a gripping position and are parallel or in alignment with a receiving unit of the platform when in a transporting position. A receiving unit of the platform receives the one or more objects from the one or more transporting surfaces. In some embodiments, the platform further includes a side transporter disposed on the platform and adjacent to at least a portion of the receiving unit and the robotic manipulator which catches fallen objects and transports them back to the receiving unit. The robotic system may further include a control circuit which is operably coupled to the robotic manipulator and the end effector. The control circuit is configured to cause the gripping and transport of the one or more objects by causing the end effector to approach the objects, the gripping interface to contact the one or more objects in an extended position, the gripping interface to grip the one or more objects, the end effector to rotate from the gripping position to the transporting position, the gripping interface to retract, and/or the transporter mechanism to transport the one or more objects on the one or more transporting surfaces to the receiving unit. The extension and retraction of the gripping interface may be substantially perpendicular to the plane defined by the one or more transporting surfaces. In some embodiments, the gripping mechanism includes suction cups, suction pads, or a combination thereof. The gripping mechanism is configured to grip a plurality of individual objects at the same time and may grip the plurality of individual objects as a bundle. The end effector may include an edge feature (e.g., raised lip, support) configured to support objects gripped by the gripping mechanism. In some embodiments, the control circuit may cause the gripping mechanism to blow out air. If the transporter mechanism includes two or more transporting surfaces, the gripping mechanism may be configured to extend and retract via one or more gaps between the transporting surfaces.

In some embodiments, a method of using a robotic system comprising a platform and a robotic manipulator on the platform is as follows. The method includes approaching an end effector of the robotic manipulator to one or more objects to be gripped, wherein the end effector includes a transporter mechanism with one or more transporting surfaces configured to move an object thereon and a gripping mechanism with a gripping interface configured to interface with the one or more objects to be gripped; contacting, with the gripping interface in an extended position, the one or more objects to be gripped; gripping, with the gripping mechanism, the one or more objects; rotating the end effector from a gripping position to a transporting position; retracting the gripping interface to a position corresponding to the one or more transporting surfaces or the position behind plane defined by the one or more transporting surfaces through the plane defined by the one or more transporting surfaces; and transporting, with the transporter mechanism, the one or more objects on the one or more transporting surfaces. The method may further include receiving, by a receiving unit on the platform, the one or more objects from the end effector. The method may further include grabbing, with a side transporter on the platform, falling objects, and bringing, with the side transporter, the falling objects to a receiving unit on the platform configured to receive the one or more objects from the end effector. The step of gripping the one or more objects may further include applying a suction force to the one or more objects, and the method may further include blowing out, via the gripping interface, air. The step of retracting the gripping interface may further include retracting the gripping interface in a direction not in the FIG. plane defined by the one or more transporting surfaces.

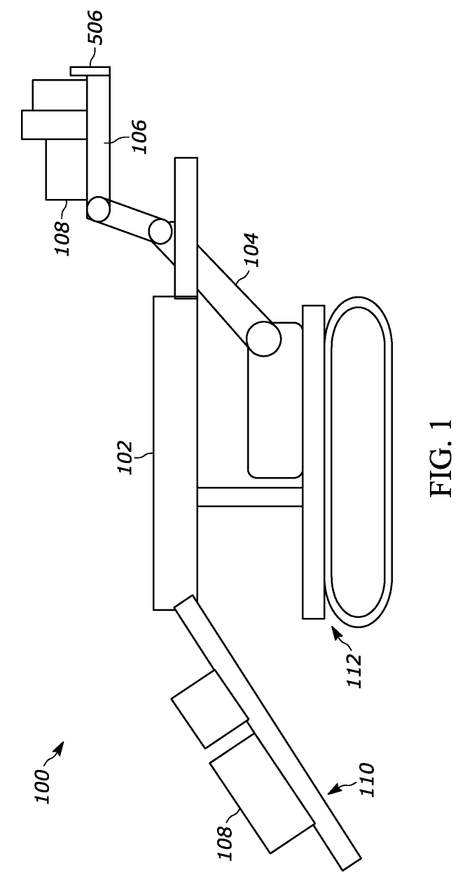

FIG. 1 illustrates a robotic system 100 for manipulating a plurality of objects. For example, the robotic system 100 may be used to unload one or more objects 108 in bulk from a trailer. The robotic system 100 includes a platform 102, a robotic manipulator 104, and a mobile base 112. The platform 102 is disposed upon the base 112, which may include wheel and/or a locomotion system for moving the robotic system 100 across the surface which the robotic system 100 is disposed upon. The base 112 may further support or be coupled to a conveyor 110 for transporting objects to and from the platform 102. The robotic system 100 may be used in multiple environments in which a plurality of objects are stacked and be configured to load and/or unload the objects in bulk (e.g., side by side and/or stacked). While many of the following embodiments focus primarily on unloading the plurality of objects from a stack onto the platform 102, it is understood that the robotic system 100 and accompanying process may be used alternatively to load the plurality of objects from the platform 102 into a stack. In some embodiments, the robotic system 100 may load or unload from a trailer, a warehouse, and/or any other suitable locations.

The platform 102 generally includes a surface for receiving objects 108 from the robotic manipulator 104. In some embodiments, the platform may have a stationary surface, such as a table, and/or a movable surface, such as a conveyor belt, wheels, or rollers. In some embodiments, the platform 102 includes multiple sections for sorting objects 108 before the objects 108 are transported to elsewhere in the facility. In some embodiments, objects on the platform 102 may be manually sorted by operators. In some embodiments, the platform 102 may include motorized components (e.g., segmented conveyor, motorized omnidirectional rollers or wheels, etc.) to sort and transport objects 108. In some embodiments a combination of motorized components and manual operators may sort, and transport objects received at the platform 102.

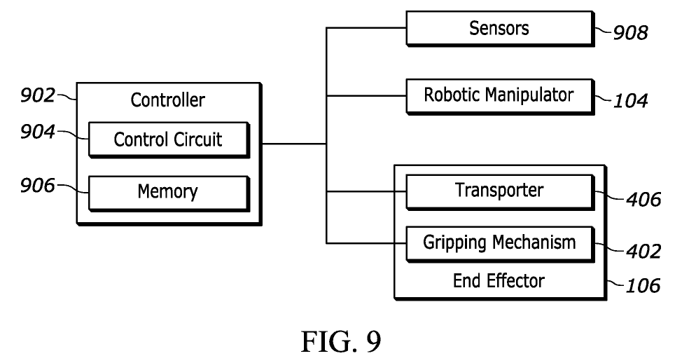

The robotic manipulator 104 is disposed on the platform 102 and further includes an end effector 106 coupled to a free end of the robotic manipulator 104. The end effector 106 is configured to grip and transport the objects 108 onto the platform 102. The robotic manipulator 104 is configured to move the end effector 106 in multiple directions and/or orientations with actions including pivoting, rotating, extending, retracting, lifting, lowering, and the like. Movement of the robotic manipulator 104 and the end effector 106 may be controlled by a controller operatively coupled to the robotic manipulator 104 and the end effector 106, such as the controller 902 as described in FIG. 9.

The conveyor 110 is configured to transport the objects 108 away from the platform 102 of the robotic system 100. The conveyor 110 may include sensors, such as the sensors 908 described in FIG. 9, to sense when the one or more objects 108 are disposed upon the conveyor 110. Further, when the objects 108 are sensed, the conveyor 110 may begin to move the objects 108 away from the platform 102 until the conveyor 110 is cleared and the objects 108 are no longer sensed on the conveyor 110. The conveyor 110 may be any suitable conveyor such as a belt conveyer, a chain conveyor, a roller conveyor, a ramp, and/or any other conveyors able to transport the objects 108 away from the platform 102.

The base 112 allows the robotic system 100 to be transported to multiple different locations in which the plurality of objects may be loaded or unloaded. The base 112 may include any suitable locomotion system including manual locomotion systems, motorized locomotion systems, and any combination of manual and motorized locomotion systems thereof. Motorized locomotion systems may include motorized belt systems, motorized wheel systems, etc. Motorized locomotion systems may be operatively coupled to and controlled by the controller 902 as described with reference to FIG. 9. Manual locomotion systems may include manual wheels, rollers, etc. In some embodiments, the locomotion system of the base 112 may automatically move the robotic system 100 toward the front of a trailer as each layer of objects is unloaded from the trailer from the back of the trailer to position the end effector 106 near the objects being unloaded. In some embodiments, the locomotion system may move the robotic system 100 to the front of a trailer, load objects, and gradually move toward the back of the trailer as layers of objects are loaded.

The objects 108 may be any object suitable to be gripped and transported by the robotic manipulator 104. For example, the objects 108 may be boxes with products inside such as would be stacked in a trailer or a warehouse. The objects 108 may include a variety of shapes, sizes, and weights, and may also include different kinds of products. For example, a retail facility which sells clothing would likely have clothes as the objects 108 in their facility, while a grocery store would likely have food related products as the objects 108 in their facility. Generally, the robotic system 100 may be utilized in any facility or business which loads and unloads a plurality of objects.

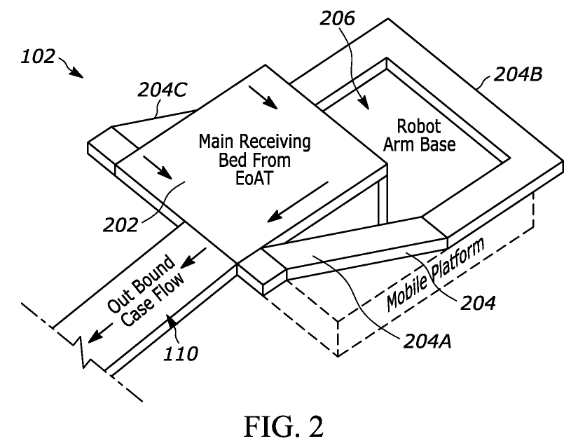

FIG. 2 is an illustration of the platform 102 according to some embodiments. The platform 102 as shown in FIG. 2 includes a receiving unit 202 and a side transporter around a robotic manipulator mount 206. The receiving unit 202 is positioned to receive objects 108 from the end effector 106 after being gripped. The conveyor 110 receives objects 108 from the receiving unit 202 and transports the objects 108 away from the platform 102. The platform 102 may further include a side transporter 204 configured to catch objects 108 fallen off of the robotic manipulator mount 206 and/or receiving unit 202 and bring the fallen objects to the receiving unit 202. FIG. 2. further illustrates a robotic manipulator mount 206 functioning as a base for mounting the robotic manipulator 104. In example embodiments, the robotic manipulator 104 is disposed upon the robotic manipulator mount 206 and is adjacent to the receiving unit 202. In some embodiments, the side transporter 204, along with the receiving unit 202, may surround the robotic manipulator mount 206 and the robotic manipulator 104.

The side transporter 204 may include multiple transport means to catch objects 108 that have fallen off of the receiving unit 202. For example, the side transporter 204 may include two sloped portions 204A, 204C and a horizontal portion 204B. A first sloped portion 204A may be one of a ramp, rollers, etc., to guide fallen objects to the horizontal portion 204B, while a second sloped portion 204C may be a motorized conveyor system to bring any fallen objects up the slope and onto the receiving unit 202. The horizontal portion 204B may be any suitable transport system such as a belt conveyor, a roller conveyor, or the like. In some embodiments, the side transporter 204 has a single direction of travel for the fallen objects, and objects that have fallen onto any section of the side transporter 204 are transported back to the receiving unit 202 along the same path. For example, if an object were to fall onto a first sloped portion 204A it would be guided down to the horizontal portion 204B. An object that has fallen onto or been guided onto the horizontal portion 204B will be transported to a second sloped portion 204C. An object that has fallen onto or been guided to the second sloped portion 204C will then be transported up to the receiving unit 202. The direction of travel may be either direction such that there is one downwards guiding slope, a horizontal portion, and an upwards guiding slope, and such that the horizontal portion guides any fallen objects towards the upwards guiding slope.

In some embodiments, the side transporter 204 has two directions of travel for fallen objects to be transported to the receiving unit 202. For example, each sloped portion 204A and 204C may include a motorized conveyer configured to bring fallen objects to the receiving unit 202, and the horizontal portion 204B may any suitable transport system to bring fallen objects to at least one of the sloped portions 204A, 204C. In some embodiments, the horizontal portion 204B may transport fallen objects to one of the two sloped portions, while in other embodiments the horizontal portion 204B may include more than one transport systems such that a first segment of the horizontal portion 204B brings fallen objects to the first sloped portion 204A, and a second segment of the horizontal portion 204B brings fallen objects to the second sloped portion 204C. For example, in embodiments where the horizontal portion 204B transports the fallen objects to one of two sloped portions 204A, 204C, an object that falls onto the first sloped portion 204A will be transported directly to the receiving unit 202, while an object that falls on the horizontal portion 204B will be transported towards the second sloped portion 204C and to the receiving unit 202. In embodiments where the horizontal portion 204B transports the fallen objects to both sloped portions 204A, 204C, an object that falls onto either sloped portion 204A, 204C will be directly transported to the receiving unit 202, while an object that falls onto the first segment of the horizontal portion 204B will be guided to the first sloped portion 204A and an object that falls onto the second segment of the horizontal portion 204B will be guided to the second sloped portion 204C. In some embodiments the first segment of the horizontal portion 204B is adjacent to the first sloped portion 204A, and the second segment of the horizontal portion 204B is adjacent to the second sloped portion 204C. The first and second segments of the horizontal portion 204B may be equal in length, or unequal in length. In some embodiments, the sloped portions may instead be a lift system that raises and lowers to bring fallen objects to the receiving unit 202 or may be any other suitable means of raising and lowering the fallen objects. The side transporter 204 may alternately be any system or means which can catch falling objects and bring the falling objects back to the receiving unit 202 (i.e., an additional robotic arm configured to catch and bring the falling objects back to the receiving unit 202).

The receiving unit 202 is, in some embodiments, adjacent to and cooperated with the conveyor 110 and the side transporter 204. The receiving unit 202 is positioned to receive objects 108 from the end effector 106 of the robotic manipulator 104. Additionally, any of the objects 108 which have fallen onto the side transporter 204 may be transported onto the receiving unit 202. The receiving unit 202 may be a static surface, a motorized surface, or a combination of a static and motorized surfaces. In embodiments where the receiving unit 202 is a static surface, the objects 108 on the receiving unit 202 may be sorted by an operator before being transported to the conveyor 110. In some embodiments the receiving unit 202 may include conveyor systems, robotic actuators, or any alternate motorized elements for sorting the objects 108 and transporting the objects 108 from the receiving unit 202 onto the conveyor 110. For example, a conveyor system of the receiving unit 202 may guide the objects 108 received at the receiving unit 202 onto the conveyor 110. Alternately, a robotic actuator may push or pull objects 108 on the receiving unit 202 to the conveyor 110. In some embodiments, a combination of operators and motorized components, such as conveyor systems and actuators, may sort and transport the objects 108 from the receiving unit 202 to the conveyor 110. In some embodiments, the conveyor 110 may accept and transport all objects 108 on the receiving unit 202 simultaneously, or only a subset (i.e., one object, 2-3 objects, or other more manageable amounts) of objects 108 on the receiving unit 202. The conveyor 110 assists in reducing congestion of a flow of the objects 108 within the robotic system 100 and within the facility in which the robotic system 100 resides. In some embodiments, the robotic system 100 further includes at least one extended structure (e.g., curtains) coupling the robotic manipulator mount 206 to portions of the side transporter 204 to prevent objects 108 from becoming stuck/caught between the robotic manipulator mount 206 and the side transporter 204. The extended structures may further assist in redirecting and/or managing where fallen objects land relative to the side transporter 204.

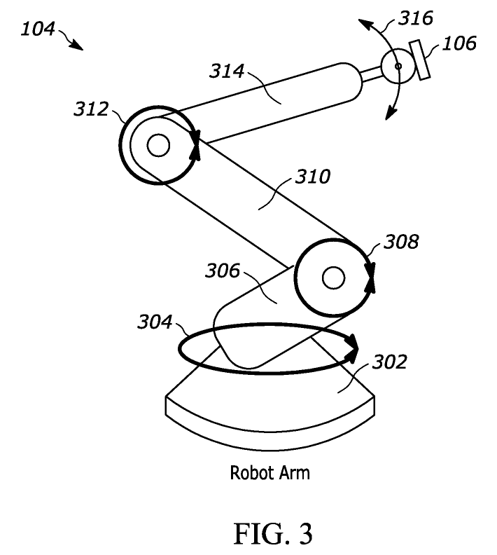

FIG. 3 is an illustration of the robotic manipulator 104 and the end effector 106 in accordance with some embodiments. In example embodiments, the robotic manipulator 104 may be a multi-axis robotic arm. The robotic manipulator 104 is configured to at least extend, retract, and rotate in a predefined plurality of directions. The robotic manipulator 104 may have at least 4 axes 304, 308, 312, 316 which it is able to move in. The axes 304, 308, 312, 316 may include movement in the x, y, and z planes, and include roll, pitch, and yaw movements. In some embodiments the axes 304, 308, 312, 316 may include axes with movement in one direction and/or more than one direction. In some embodiments, the robotic manipulator 104 includes a first axis 304 of which a first segment 306 moves about a base 302 of the robotic manipulator 104, a second axis 308 of which a second segment 310 moves about the first segment 306, a third axis 312 of which a third segment 314 moves about the second segment 310, and a fourth axis 316 of which the end effector 106 moves about the third segment 314. While FIG. 3 shows a robotic manipulator 104 with 4 axes 304, 308, 312, 316, in some embodiments the robotic manipulator 104 may include a different number of axes.

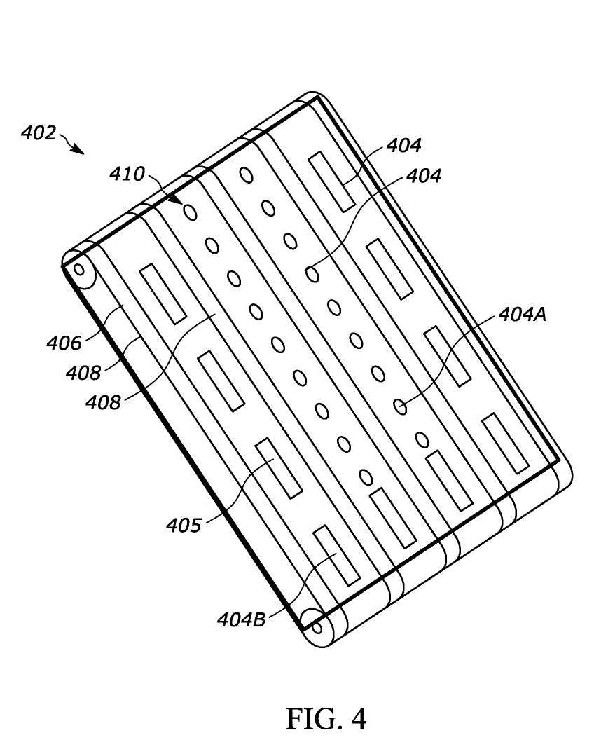

FIG. 4 is an illustration of the end effector 106 in accordance with some embodiments. The end effector 106 includes a gripping mechanism 402 and a transporter mechanism 406 that can grip objects and move the gripped objects along the end effector 106. The transporter mechanism 406 includes one or more transporting surfaces 408 arranged for moving the objects 108 thereon. The gripping mechanism 402 includes one or more gripping interfaces 404 configured to interface with objects 108.

In some embodiments, the gripping interface 404 is configured to extend outwardly beyond a plane 410 defined by transporting surfaces 408 of the transporter mechanism 406 and retract to a position corresponding to the plane 410 or behind the plane 410. In some embodiments, the extension may be perpendicular or at an angle to the plane 410. In some embodiments, the gripping interface 404 extends and retracts via one or more openings in the plane 410. In some embodiments, each gripping interface 404 of the gripping mechanism 402 may include an active vacuum suction gripper, a passive suction cup, a self-sealing suction cup, or a combination thereof. In some embodiments, suction may be released by cutting off the airflow to an active gripping interface 404. In additional embodiments, the gripping mechanism 402 may include release components 404A connected to an air supply that can blow out air and/or release vacuum to remove suction and dislodge objects from the gripping interface 404. The components 404A, 404B may have a variety of shapes, sizes, arrangements, and quantities. While FIG. 4 shows components 404A and 404B as multiple openings spaced along the length of the plane 410, in some embodiments, suction components 404A and/or release components 404B may be any length, width, or arrangement on the gripping mechanism 402.

The transporter mechanism 406 includes one or more transporting surfaces 408 defining a part of the plane 410. The transporting surfaces 408 may be positioned in gaps between one or more columns of suction components 404A and/or release components 404B. A transporting surface 408 of the transport mechanism 406 is generally configured to move objects from one end (distal or proximal) of the gripping mechanism 402 towards another. In some embodiments, the transporter mechanism 406 may be bidirectional and configured to reverse the direction of transport based on commands received from a controller. In some embodiments, the transporting surface 408 may comprise conveyor belts, motorized rollers, motorized wheels, etc. In some embodiments, a transporting surface 408 of the transport mechanism 406 may include passive wheels or rollers that reduce friction to facilitate transport via other active transport surfaces and/or with the tiling of the gripping mechanism 402. The gripping mechanism 402 may be operated in conjunction with the end effector 106 and robotic manipulator 104 to grip objects 108 with the gripping interface 404. The robotic manipulator 104 and the gripping mechanism 402 can together cause the gripping interface 404 to contact the objects 108 to grip of the objects 108 with the suction means on the gripping interface 404. The gripping mechanism 402 may further include any other components for facilitating the gripping process. For example, the gripping mechanism 402 may further include a housing for the gripping interface 404, an end effector mount, sensors such as the sensors 908 described in FIG. 9, and/or any other components that may be used to facilitate the gripping of the objects 108 but do not directly contact the objects 108.

The transporter mechanism 406 may be operated in conjunction with the end effector 106 and the robotic manipulator 104 to transport objects 108. For example, robotic manipulator 104 may move the end effector 106 proximal to the receiving unit 202 to transport objects 108 off of the end effector 106 via transporting surface 408 of the transporting surfaces 408. In some embodiments, the transporter mechanism 406 may include other components that facilitate the transporting process, such as a housing for one or more transporting surfaces 408, an end effector mount, sensors such as the sensors 908 described in FIG. 9, a motor to drive the conveyors on the one or more transporting surfaces 408, and/or any other components that may be used to facilitate the transporting of the objects 108.

In some embodiments, the transporter mechanism 406 may be a motorized transport system or a passive transport system. A passive transport system may include stationary ramps, rollers, etc., to transport the objects 108, while a motorized transport system may include gears, chains, motors, etc., to transport the objects 108. In some embodiments the transporter mechanism 406 may include a drive system, such as a conveyor system, which includes gears, chains, motors, etc., while the one or more transporting surfaces 408 may be the surfaces of the conveyor system being used to transport the objects 108. In some embodiments, the transporter mechanism 406 may include one drive system to drive the movement of each of the one or more transporting surfaces 408, in alternate embodiments, the transporter mechanism 406 may include multiple drive systems to separately drive the movement of the one or more transporting surfaces 408. In embodiments, each drive system may drive one or multiples of the one or more transporting surfaces 408 of the transporter mechanism 406.

In some embodiments, the one or more transporting surfaces 408 may be any combination of rollers, belts, and/or like surfaces of a conveyor system which the objects 108 rest upon during transport. Each of the one or more transporting surfaces 408 may be able to move independently of each other or simultaneously. Some of the one or more transporting surfaces 408 may be controlled in groups (i.e., two transporting surfaces 408 may begin moving together, while a third begins movement later). While FIG. 4 shows gripping interfaces 404 and transporting surfaces 408 being disposed in separate vertical columns along the direction of transport, in some embodiments, one or more columns of an end effector 106 may include a mix of gripping interfaces 404 and transporting surfaces 408. For example, a roller may be vertically positioned between two suction elements. In some embodiments, there may be gaps 405 between some of the transporting surfaces 408 in which the gripping interface 404 is disposed. In alternate embodiments, the one or more transporting surfaces 408 may have gaps 405 between adjacent transporting surfaces 408, and the gripping interface 404 may be configured to extend or retract through the gaps 405. In yet other embodiments, the one or more transporting surfaces 408 may have openings that move with the one or more transporting surfaces 408 (i.e. a conveyor system with openings that rotate with the conveyor), and the gripping interface 404 may be configured to suction and/or blow air through the openings via the components 404B, 404A, respectively. The gripping mechanism 402 may include any combination of gaps 405 between the one or more transporting surfaces 408 and openings on the one or more transporting surfaces 408 to interface the objects 108 via the gripping interface 404.

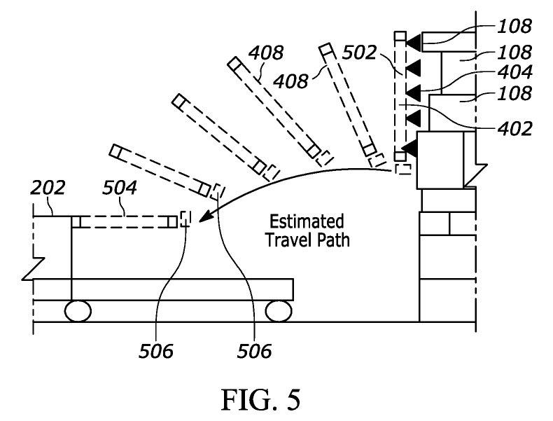

In some embodiments, the end effector 106 includes an edge feature configured to support the objects 108 gripped by the gripping mechanism 402. In some embodiments, the edge feature may be a lip 506 depicted in FIG. 5. The edge feature may be disposed upon an end of the one or more transporting surfaces 408 that is distal to the receiving unit 202 when in the transporting position 504. The edge feature may further provide support for any of the objects 108 that the gripping interface 404 was unable to establish contact with, so that an ungripped object of the objects 108 is less likely to fall off of the end effector 106 and onto the side transporter 204 during transport. In some embodiments, the edge feature is generally a support structure located on the perimeter (e.g., bottom, sides, and/or top) of the end effector 106 to support objects 108 gripped by the end effector 106.

In some embodiments, the gripping mechanism 402 and the transporter mechanism 406 reside in the same housing or separate housings of the end effector 106 and are cooperated with each other. In some embodiments, the gripping mechanism 402 and the transporter mechanism 406 may be controlled by the same control circuit and/or share one or more components. In some embodiments, the gripping mechanism 402 and the transporter mechanism 406 may be independently controlled via different control circuits.

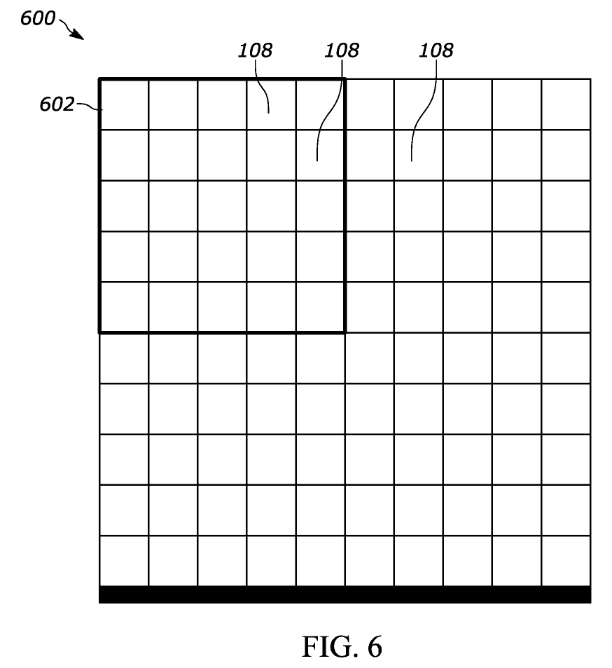

FIG. 5 is an illustration of an example travel path of an end effector 106 during gripping and transporting of the objects 108. When gripping the objects 108, the one or more transporting surfaces 408 are generally upright in a gripping position 502 and the end effector 106 extends towards a face, such as the face 600 described in FIG. 6, of the objects 108. The gripping interface 404 may extend outwards of the gripping mechanism 402 to contact the face and grip the objects 108. Once the objects 108 have been gripped, the end effector 106 pivots radially and retracts away from the objects 108, effectively leaning backwards during travel to reach a transporting position 504 generally parallel to or in alignment with the receiving unit 202. During travel from the gripping position 502 to the transporting position 504, the leaning back of the one or more transporting surfaces 408 allows the objects 108 to rest on the transporting surfaces 408 via gravity during transport to reduce the amount of the objects 108 which fall onto the side transporter 204. In some embodiments, objects 108 not suctioned by the gripping mechanism 402 may be cradled between suctioned objects until being transported by the transporter mechanism 406. The end effector 106 may further include a lip 506 disposed on the end of the one or more transporting surfaces 408 opposite the receiving unit 202 to support any objects 108 not suctioned by the gripping mechanism 402. During travel from the gripping position 502 to the transporting position 504, the gripping interface 404 of the gripping mechanism 402 may actively grip the objects 108 until arrival in the transporting position 504. Once arrived in the transporting position 504, the gripping interface 404 may release the suction before the transporter mechanism 406 begins to transport the objects 108. After releasing the objects 108 being gripped, the gripping interface 404 may further blow air out in the direction of the objects 108 to dislodge any of the objects 108 which may still be suctioned to the gripping mechanism 402 via the gripping interface 404. Once the one or more transporting surfaces 408 are in the transporting position 504, the one or more transporting surfaces 408 move the objects 108 thereon onto the receiving unit 202 of the platform 102.

FIG. 6 is an illustration of a face 600 of stacked objects 108 to be unloaded, such objects 108 as it may be seen stacked inside a trailer. As shown, the objects 108 of the face 600 may further include a bundle 602 consisting of a plurality of individual objects. The gripping mechanism 402 is able to grip objects in bulk (i.e., multiples at the same time) as a group of loose objects or in a bundle. A space holding stacked objects may include a depth, a width, and a height, and may confined by for example, a left-hand wall, a right-hand wall, a ceiling, and a floor. In some embodiments, the objects 108 may fill the entirety of the dimensions available in the trailer, in other embodiments the objects 108 may not fill the entirety of the dimensions available in the trailer (i.e. the objects 108 may not fill the maximum height, width, or depth accessible, and instead fill part of any of the height, width, or depth accessible). In some embodiments, the objects 108 may each be of a different size, and the objects 108 may not line up exactly at the same spot of the face 600 of the objects 108 (i.e., the front sides of the objects 108 accessed by the robotic system 100 may be at different depths). Further, the gripping mechanism 402 of the robotic system 100 is able to grip and transport the objects 108 even if the gripping interface 404 is unable to establish contact with each object 108 such as may occur if the front sides of some of the objects 108 are at different depths. Additionally, as the one or more transporting surfaces 408 are leaned backwards during travel from the gripping position 502 to the transporting position 504, objects 108 that the gripping interface 404 was unable to establish contact with are rested onto the transporting surfaces 408 by gravity before being transported to the receiving unit 202.

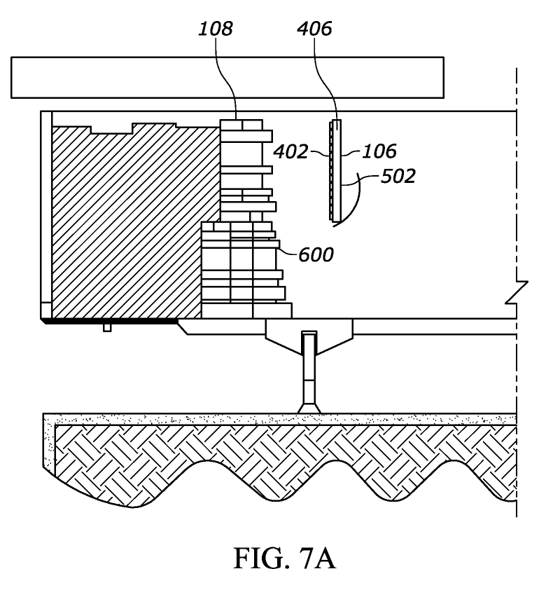

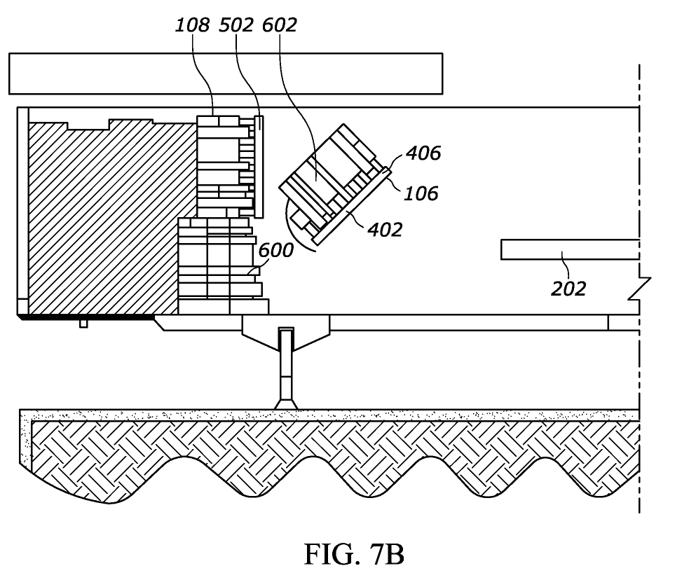

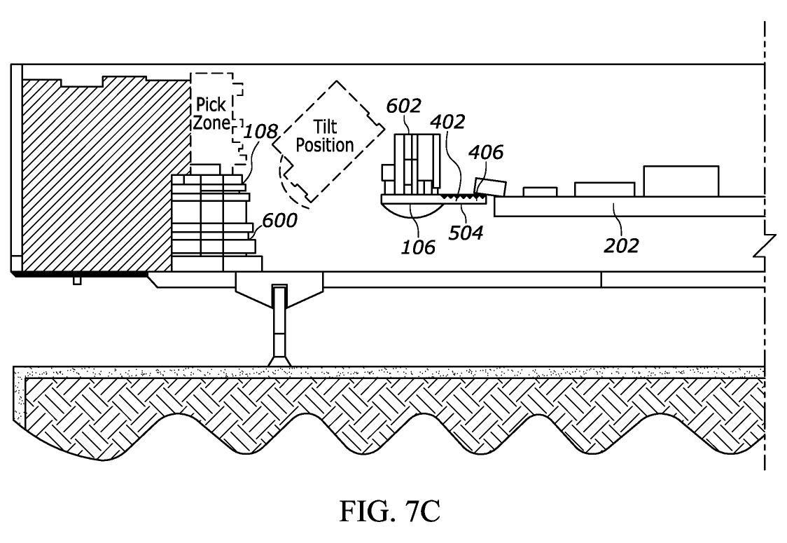

FIGS. 7A-7C illustrate the robotic system 100 unloading objects 108 from a trailer bed. In FIG. 7A, the end effector 106 includes the gripping mechanism 402 and the transporter mechanism 406 for gripping and transporting objects 108 in the trailer bed. The end effector 106 generally begins in a gripping position 502 with the gripping mechanism 402 directed towards a face 600 of objects 108. In FIG. 7B, the gripping interface 404 of the gripping mechanism 402 may extend outwards towards the face 600 of objects 108. In some embodiments, the gripping mechanism 402 may include one or more gripping interfaces 404, and each of the gripping interfaces 404 may suction a subset (e.g., a quadrant) of objects 108 of a bundle 602 of objects 108. Each of the gripping interfaces 404 may be able to individually extend different distances depending on the distance of the gripping interface 404 to an adjacent subset of objects 108 within the bundle 602. The gripping interfaces 404 may suction a bundle 602 of the objects 108 from the face 600. After suctioning the bundle 602 of objects 108, the end effector 106 may begin to lean backward while retaining the bundle 602 of objects 108 in place on the gripping mechanism 402. The end effector 106 may lean backward towards a receiving unit 202. In FIG. 7C, the end effector 106 may lean backward until reaching a transporting position 504 in which the one or more transporting surfaces 408 of the transporter mechanism 406 are generally adjacent to the receiving unit 202. Once in the transporting position 504, the gripping interface 404 of the gripping mechanism 402 may release the suctioned bundle 602 of objects 108, for example, by expelling air from the gripping interface 404. In some embodiments, there may be one or more gripping interfaces 404, and the gripping interfaces 404 may release the objects 108 one row at a time, beginning with a row of gripping interfaces 404 closest to the receiving unit 202 and followed by each subsequent adjacent row of gripping interfaces 404. Once the objects 108 are released, the one or more transporting surfaces 408 may begin to transport the objects 108 onto the receiving unit 202.

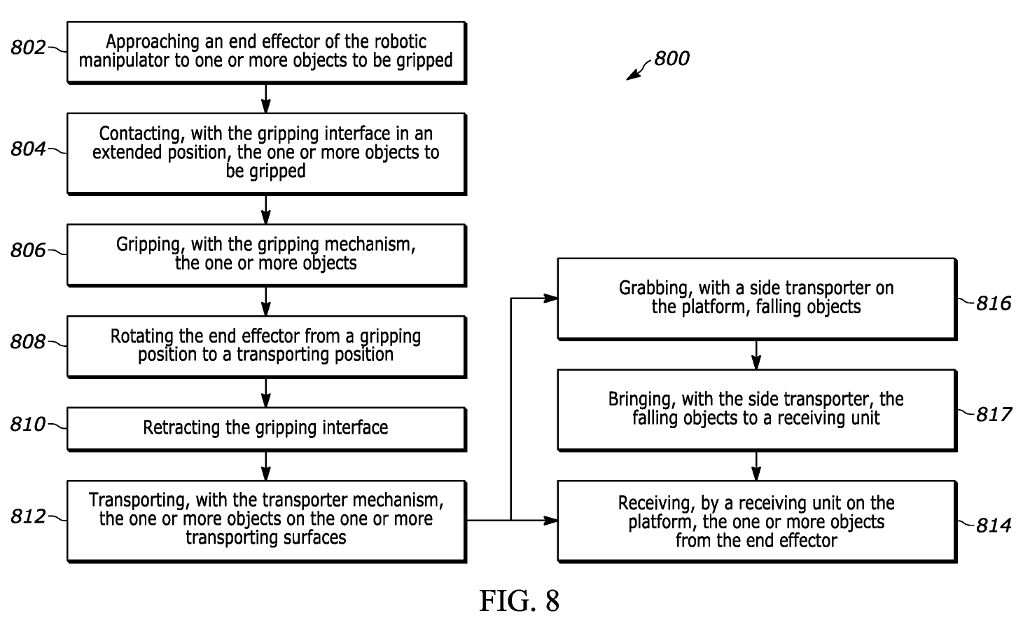

FIG. 8 is a flow diagram of an example method 800 which includes steps for unloading the objects 108 from a trailer using the robotic system 100 which includes the robotic manipulator 104 on the platform 102.

In the first step 802, the end effector 106 of the robotic manipulator 104 approaches the objects 108 to be gripped. The end effector 106 includes the transporter mechanism 406 with the one or more transporting surfaces 408 configured to move an object thereon and the gripping mechanism 402 with the gripping interface 404 configured to interface with the objects 108 to be gripped.

In step 804, the gripping interface 404 is actuated to an extended position and contacts the objects 108 to be gripped.

In step 806, the gripping mechanism 402 grips the objects 108 via the gripping interface 404. In some embodiments, step 806 may further include the gripping interface 404 applying a suction force to the objects 108 as the objects 108 are being gripped.

In step 808, the end effector 106 is rotated from the gripping position 502 to the transporting position 504.

In step 810, the gripping interface 404 is retracted to a position corresponding to the one or more transporting surfaces 408 or the position behind the plane defined by the one or more transporting surfaces 408 through the plane defined by the one or more transporting surfaces 408. In some embodiments, step 810 may further include retracting of the gripping interface 404 in a direction not in the plane defined by the one or more transporting surfaces 408.

In step 812, the transporter mechanism 406 transports the objects 108 on the one or more transporting surfaces 408. The one or more transporting surfaces 408, in some embodiments, may be a conveyor belt, in which when the one or more transporting surfaces 408 are in the transporting position 504, the conveyor belt activates and transports the objects 108 onto the receiving unit 202. In some embodiments, steps 810 and 812 may be reversed. For example, the gripping interface may continue to apply suction during the transportation of the objects toward the receiving unit and release the suction only upon arrival at the receiving unit. In some embodiments, this is the final step in the method 800, however, in alternate embodiments, additional steps may follow step 812.

The method 800 may further include step 814 after step 812, during which the receiving unit 202 on the platform 102 receives the objects 108 from the end effector 106.

In alternate embodiments, the method 800 may further include step 816 after step 812, during which the side transporter 204 on the platform 102 receives falling objects. Following step 816 is step 817, in which the side transporter 204 brings the falling objects to the receiving unit 202 on the platform 102 configured to receive the objects 108 from the end effector 106. The side transporter 204 may use a transport means, such as a conveyor belt, to transport the fallen objects onto the receiving unit 202.

The method 800 may further include a step comprising blowing out air via the gripping interface 404. When the end effector 106 has moved from the gripping position 502 to the transporting position 504, the gripping interface 404 may blow out air in order to disconnect any of the objects 108 gripped to the gripping interface 404 so that the transporter mechanism 406 is able to transfer the objects 108 to the receiving unit 202.

In some embodiments, during steps 802-812, the robotic system 100 may further detect the limits of the space that the objects are stored in and store the limits in a memory storage to determine the bounds of movements of a robotic manipulator 104. In the example of a trailer unloading, when beginning to unload the objects 108, the platform 102 is transported into the trailer via the base 112. Once inside the trailer, the robotic manipulator 104 extends so that the end effector 106 finds the upper-left side of the trailer where the left-hand wall meets the ceiling and implements a limit with the location. The limit is then stored in memory, such as memory 906 as described in FIG. 9, so that during the unloading of the objects 108 the robotic manipulator 104 does not extend outside of the confines of the space. Once the upper-left limit has been defined, the robotic manipulator 104 will proceed to advance towards the face 600 of the plurality of objects, storing the distance to the face 600 in the memory 906, and begin to grip and transport the objects 108. The robotic manipulator 104 will continue moving towards the right with each new cycle of gripping and transporting of the objects 108, until the end effector 106 of the robotic manipulator 104 extends and finds the upper-right side of the trailer where the right-hand wall meets the ceiling. The upper-right limit may be stored in the memory 906. After finding the upper-right limit, the robotic manipulator 104 and the end effector 106 may then proceed to move down and to the left-hand wall, beginning to grip and transport the objects 108 below the objects 108 previously gripped and transported (i.e. the robotic manipulator 104 grips and transports the objects 108 from left to right, moving down to repeat the process after each row is cleared). The same process may be used to define a lower-left limit and a lower-right limit, and these limits may be stored in the memory 906.

FIG. 9 illustrates a block diagram of the robotic system 100 in accordance with some embodiments. The robotic system 100 includes the robotic manipulator 104, the end effector 106, sensors 908, and a controller 902. The controller 902 further includes a control circuit 904 and a memory 906, and is operatively coupled to the sensors 908, the robotic manipulator 104, and the end effector 106. The control circuit 904 of the controller 902 is operatively coupled to the robotic manipulator 104 and is configured to perform various functions. These functions include causing the end effector 106 to approach the one or more objects 108 to be gripped, causing the gripping interface 404 in an extended position to contact the objects 108, and causing the gripping mechanism 402 to grip the objects 108. The functions further include causing the end effector 106 to rotate from the gripping position 502 to the transporting position 504, causing the gripping interface 404 to retract to the position corresponding to the one or more transporting surfaces 408 or the position behind the plane defined by the one or more transporting surfaces 408 through the plane defined by the one or more transporting surfaces 408, and causing the transporter mechanism 406 to transport the objects 108 on the one or more transporting surfaces 408 to the receiving unit 202. The control circuit 904 may be further configured to cause the gripping mechanism 402 to blow out air, which may effectively break the grip the gripping interface 404 has on the objects 108 prior to transporting the objects 108 onto the receiving unit 202. Generally, the controller 902 may be configured to perform or cause the end effector 106 to perform one or more steps described with reference to FIG. 9.

The control circuit 904 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 904 can be part of control circuitry and/or a controller 902, which may be implemented through one or more processors with access to one or more of the memory 906 that can store instructions, code and the like that is implemented by the control circuit 904 and/or processors to implement intended functionality. In some applications, the control circuit 904 and/or memory 906 may be distributed over a communications network (e.g., LAN, WAN, Internet) providing distributed and/or redundant processing and functionality. The robotic system 100 may be used to implement one or more of the above or below, or parts of, components, circuits, systems, processes, and the like. Again, the robotic system 100 includes an example of a control and/or processor-based system with the control circuit 904. The control circuit 904 can be implemented through one or more processors, controllers, central processing units, logic, software, and the like. Further, in some implementations the control circuit 904 may provide multiprocessor functionality.

The memory 906, which can be accessed by the control circuit 904, typically includes one or more processor-readable and/or computer-readable media accessed by at least the control circuit 904, and can include volatile and/or nonvolatile media, such as RAM, ROM, EEPROM, flash memory and/or other memory technology. Further, the memory 906 is shown as internal to the controller 902; however, the memory 906 can be internal, external or a combination of internal and external memory. Similarly, some or all of the memory 906 can be internal, external or a combination of internal and external memory of the control circuit 904. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network. The memory 906 can store code, software, executables, scripts, data, content, lists, programming, programs, log or history data, user information, customer information, product information, and the like.

The sensors 908 may be coupled to the conveyor 110 as described in FIG. 1 in order to detect if the objects 108 are actively on the conveyor 110. In embodiments in which the conveyor 110 is a motorized conveyor, if the sensors 908 detect the objects 108 on the conveyor 110, the controller 902 and control circuit 904 will cause the conveyor 110 to begin to transport the objects 108 away from the platform 102. When the sensors 908 do not detect the objects 108 on the conveyor 110, the control circuit 904 will cause the conveyor 110 to stop transport if actively transporting or remain at rest if not actively transporting. In some embodiments, the sensors 908 may include limit switches configured to detect the presence or absence of an object and to actuate or stop actuation of components of the robotic system 100 accordingly. In some embodiments, such as embodiments including limit switches, the controller 902 may not require a memory 906 and may instead utilize live input/output data from the sensors 908.

In some embodiments, the sensors 908 may be used to sense if any of the objects 108 have fallen onto the side transporter 204. If the sensors 908 detect any of the objects 108, the controller 902 and the control circuit 904 may cause the side transporter 204 to activate and bring the fallen objects back onto the receiving unit 202. When the sensors do not detect any of the objects 108 on the side transporter 204, control circuit 904 may cause the side transporter 204 to stop moving if actively transporting or remain at rest if not actively transporting.

The sensors 908 may additionally be used to detect the location of the robotic system 100 and the robotic manipulator 104 with respect to the environment in which the robotic system 100 resides. If the robotic system 100 is in a trailer, the sensors 908 are able to sense at least a left hand wall, a right hand wall, a ceiling, and a face 600 of the plurality of objects.

It is understood that while the embodiment described above is a left to right process beginning at the top of a trailer, any alternate pattern or sequence of unloading may be used (i.e., right to left top to bottom). While beginning unloading the objects 108 from the top of the face 600 may be preferred (for example, unloading the objects 108 starting from the bottom may result in damaged products as objects above the objects 108 being gripped fall into the newly empty space) any pattern of unloading is possible. Alternately, in a situation where the objects 108 are being loaded rather than unloaded, it may be preferred to load from the bottom up.

The sensors 908 may be utilized to sense a variety of features in a variety of locations. The sensors 908 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A robotic system comprising:
a platform; and
a robotic manipulator on the platform, the robotic manipulator comprising an end effector comprising:
a transporter mechanism with one or more transporting surfaces configured to move an object thereon; and
a gripping mechanism with a gripping interface configured to interface with one or more objects to be gripped, wherein the gripping interface is configured to extend outwardly beyond a plane defined by the one or more transporting surfaces and retract to a position corresponding to the one or more transporting surfaces or a position behind the plane defined by the one or more transporting surfaces through the plane defined by the one or more transporting surfaces.

2. The robotic system of claim 1, wherein the gripping interface is configured to extend and retract in a direction not in the plane defined by the one or more transporting surfaces.

3. The robotic system of claim 1, wherein the gripping interface is configured to extend and retract in a direction substantially perpendicular to the plane defined by the one or more transporting surfaces.

4. The robotic system of claim 1, wherein the gripping interface comprises one or more suction cups, one or more suction pads, or a combination thereof.

5. The robotic system of claim 1, wherein the gripping mechanism is configured to grip, via the gripping interface, a plurality of individual objects at the same time.

6. The robotic system of claim 1, wherein the gripping mechanism is configured to grip, via the gripping interface, a plurality of individual objects as a bundle.

7. The robotic system of claim 1, wherein the robotic manipulator is a multi-axis robotic arm.

8. The robotic system of claim 1 further comprising a receiving unit configured to receive the one or more objects from the end effector.

9. The robotic system of claim 8 further comprising a side transporter configured to catch falling objects and bring the falling objects to the receiving unit.

10. The robotic system of claim 9, wherein the side transporter is disposed on the platform and adjacent to at least a portion of the receiving unit and the robotic manipulator.

11. The robotic system of claim 1, wherein a control circuit operably coupled to the robotic manipulator is configured to:
cause the end effector to approach the one or more objects to be gripped;
cause the gripping interface in an extended position to contact the one or more objects;
cause the gripping mechanism to grip the one or more objects via the gripping interface;
cause the end effector to rotate from a gripping position to a transporting position;
cause the gripping interface to retract to the position corresponding to the one or more transporting surfaces or the position behind the plane defined by the one or more transporting surfaces through the plane defined by the one or more transporting surfaces; and
cause the transporter mechanism to transport the one or more objects on the one or more transporting surfaces to a receiving unit.

12. The robotic system of claim 11, wherein the one or more transporting surfaces are upright in the gripping position.

13. The robotic system of claim 11, wherein the one or more transporting surfaces are parallel to or in alignment with the receiving unit in the transporting position.

14. The robotic system of claim 11, wherein the control circuit is further configured to cause the gripping interface to blow out air.

15. The robotic system of claim 1, wherein the end effector further comprises an edge feature configured to support objects gripped by the gripping mechanism.

16. The robotic system of claim 1, wherein the transporter mechanism comprises two or more transporting surfaces configured to move an object thereon and the gripping interface is configured to extend and retract via one or more gaps between the two or more transporting surfaces.

17. A method of using a robotic system comprising a platform and a robotic manipulator on the platform, the method comprising:
approaching an end effector of the robotic manipulator to one or more objects to be gripped, wherein the end effector comprises a transporter mechanism with one or more transporting surfaces configured to move an object thereon and a gripping mechanism with a gripping interface configured to interface with the one or more objects to be gripped;
contacting, with the gripping interface in an extended position, the one or more objects to be gripped;
gripping, with the gripping mechanism, the one or more objects via the gripping interface;
rotating the end effector from a gripping position to a transporting position;
retracting the gripping interface to a position corresponding to the one or more transporting surfaces or the position behind plane defined by the one or more transporting surfaces through the plane defined by the one or more transporting surfaces; and
transporting, with the transporter mechanism, the one or more objects on the one or more transporting surfaces.

18. The method of claim 17 further comprising receiving, by a receiving unit on the platform, the one or more objects from the end effector.

19. The method of claim 17 further comprising:
grabbing, with a side transporter on the platform, falling objects; and
bringing, with the side transporter, the falling objects to a receiving unit on the platform configured to receive the one or more objects from the end effector.

20. The method of claim 17, wherein the step of gripping the one or more objects comprises applying a suction force to the one or more objects.

21. The method of claim 17 further comprising blowing out, via the gripping interface, air.

22. The method of claim 17, wherein the step of retracting the gripping interface comprises retracting the gripping interface in a direction not in the plane defined by the one or more transporting surfaces.
